(19) United States
(12) Patent Application Publication
(10) Pub. No.: US 2005/0220674 A1
(43) Pub. Date: Oct. 6, 2005

(54) Tissue electro-sectioning apparatus

(76) Inventors: Gal Shafirstein, Little Rock, AR (US); Scott L. Ferguson, Vilonia, AR (US); Louis M. Fink, Las Vegas, NV (US); Richard K. Ulrich, Springdale, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 11/091,873

(22) Filed: Mar. 28, 2005

Related U.S. Application Data
(63) Continuation-in-part of application No. 10/816,016, filed on Apr. 1, 2004.

(51) Int. Cl. B01L 3/00

(52) U.S. Cl. 422/99

(57) ABSTRACT

An apparatus for sectioning fresh unfixed tissue into very thin layers with preserved tissue architecture, antigenicity, mRNA content, and amenable to 3-D computer reconstruction without mechanical or thermal damage by employing a sectioning tool having an electrode with an intense focused electrical field at an edge. A computer controlled x-y-z translation stage moves the sectioning tool through the tissue as defined by a predetermined program. The sectioning tool produces consecutive thin sections of fresh tissue for immunohistochemical and nucleic acids analyses without mechanical or thermal damage, ultimately allowing high-resolution volumetric reconstruction of gene and protein expression patterns of large tissue specimens. The geometry of the sectioning tool is selected so as to produce a spatially localized electrical field of sufficient intensity to sever molecular bonds or propagate flaws in tissue without mechanical cutting.

### CROSS-REFERENCE TO RELATED APPLICATIONS

This application is a continuation-in-part of co-pending U.S. patent application Ser. No. 10/816,016 filed Apr. 1, 2004, the disclosure of which is incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to the automated sectioning or separating of consecutive thin sections of fresh tissues by electro-dissociation without mechanical force or thermal damage to the tissue. By shearing molecular bonds, damage to collateral tissue is avoided. Also, the need for tissue pre-processing along with the adverse effects associated with these preparation techniques is eliminated. The apparatus of the present invention may also be used for sectioning tissues in various surgical applications.

2. Brief Description of the Related Art

The preparation of tissue for histopathological and immunohistochemical analysis has remained unchanged for almost a century. Basically, a very sharp blade is used to cut thin sections of material for analysis. In order to achieve very thin sections, the tissue must be frozen or embedded in paraffin. Although frozen sectioning is relatively fast and effective it produces poor histologic-quality sections due to ice-crystal artifacts. Paraffin embedding produces better image quality sections but entails long processing times (12-24 hours). Furthermore, it must follow fixation in aldehyde-based formulations (e.g. formalin) which induces extensive protein cross-linking or alcohol-based (non-cross linking) fixation that preserves nucleic acid but does not reduce the processing time. Hence, none of these techniques allow tissue sectioning in thin layers that can be processed rapidly and produce high quality thin tissue specimens.

Routine histochemical analyses of thin tissue sections by light microscopy using chemical stains such as hematoxylin and eosin to highlight general nuclear and cytoplasmic features is the mainstay of surgical pathological diagnosis as well as morphological research. Another method, immunohistochemistry, provides more specific information about tissue sections by tagging a molecule of interest. Immunohistochemistry works on the principle of using an exogenous antibody raised against the molecule that is linked either to a fluorescent tag or to an enzyme that produces a local color reaction upon exposure to an appropriate chromagen. Immunohistochemistry allows phenotypic markers to be detected and interpreted within a morphologic context, making this methodology an essential tool in both diagnostic pathology and research.

The most widespread use of immunohistochemistry in pathology is to supplement morphologic criteria in determining the appropriate classification of neoplasms by revealing the expression of specific proteins or other antigens in these tissues. Recent advances in molecular biology now allow detection by light microscopy of specific DNA and mRNA sequences within tissues via in situ hybridization. Nucleic acids can also now be amplified in situ by polymerase chain reaction (PCR) prior to detection by hybridization. Laser capture microdissection methods using frozen tissue sections combined with ultra-sensitive linear amplification and reverse transcriptase PCR (RT-PCR) have allowed successful gene expression analyses on small numbers of cells of specific type or location selectively “plucked” from the tissue by a laser under light microscope guidance.

Unfortunately, traditional tissue fixation and processing prior to paraffin-embedding destroys many immunohistochemical target antigens and mRNA target sequences. This problem can in part be alleviated by the use of frozen, unfixed sections in which antigenic and nucleic acid targets are preserved. However, frozen sections are of poor histological quality due to ice-crystal artifacts, thus making them unsuitable for laser capture studies and 3-dimensional reconstruction of morphology or gene expression patterns.

Currently available tissue sectioning techniques employ either a rigid blade microtome or a vibratome. While the microtome cuts by forcing the tissue against a blade, the vibratome cuts with a sawing action as the oscillating blade pushes against the tissue. With both devices, the tissue can be cut at room temperature or cryogenic temperatures (e.g., −20° C.). (Kan, R., et al., Free-floating cryostat sections for immunoelectron microscopy: Bridging the gap from light to electron microscopy. Microsc Res Tech 54(4): 246-53 (2001); Kenny-Moynihan, M., et al., Immunohistochemical and in situ hydridization techniques, Advanced Diagnostic Methods in Pathology, (2002); Halbhuber, K., et al., Modern laser scanning microscopy in biology, biotechnology and medicine. Ann Anat 185(1): 1-20 (2003)).

Vibratome sectioning of frozen tissues is sometimes used in the research setting, but is not advantageous in the clinical setting. Sectioning of fresh tissues without freezing (and therefore without ice artifacts) requires either that the tissue be fixed and immobilized in paraffin, or cut with a vibratome. Unfortunately, the vibratome cannot produce sections of soft tissues that are thin enough for high resolution work (4-10 μm) without rigidifying the specimen by freezing or fixing prior to sectioning. The minimum thickness of vibratome sections of unfrozen, unfixed tissue is about 40 μm at room temperature and in practice 60-100 μm. (Sallee, C., et al., Embedding of neural tissue in agarose or glyoxyl agarose for vibratome sectioning. Biotech Histochem 68(6): 360-8 (1993); Stuart, D., et al., Embedding, sectioning, immunocytochemical and stereological methods that optimize research on the lesioned adult rat spinal cord. J Neurosci Methods 61(1-2): 5-14 (1995); Luchtel, D., et al., Histological methods to determine blood flow distribution with fluorescent microspheres. Biotech Histochem 73(6): 291-309 (1998); Ghosh, F., et al., Partial and full-thickness neuroretinal transplants. Exp Eye Res 68(1): 67-74 (1999); Kan, R., et al., Free-floating cryostat sections for immunoelectron microscopy: Bridging the gap from light to electron microscopy. Microsc Res Tech 54(4): 246-53 (2001); Halbhuber, K., et al., Modern laser scanning microscopy in biology, biotechnology and medicine. Ann Anat 185(1): 1-20 (2003)). Hence, there is a need for a technique that can slice fresh unprocessed tissue into thin sections (6-10 μm) amenable for intraoperative surgical pathologic examination.

Frozen sectioning using a rigid microtome blade in a so-called “cryostat” is fast and can produce very thin sections. Frozen sectioning eliminates thermal and chemical damage to protein and nucleic acid structure, but is associated with ice crystal artifacts that obscure important histological features. Albeit distorted by ice artifacts, this is the routine method of tissue sectioning for intra-operative surgical pathology.

Since large hexagonal ice crystals that form within the tissue during freezing cause more major structural damage than small ice crystals, ice artifacts can be reduced by rapid cooling of the tissue. Ice crystal formation cannot in practice be eliminated, because the extreme cooling rates needed to produce solid amorphous ice, or vitreous ice, cannot be realistically achieved. (Dubochet, J., et al., Amorphous solid water produced by cryosectioning of crystalline ice at 113 K. J Microsc 207(Pt 2): 146-53 (2002)).

Since traditional mechanical tissue sectioning methodologies require rigidified specimens to produce thin sections, we have examined the possibility of sectioning soft tissue in their native, pliable state with electromagnetic energy. The effect of radio frequency (RF) power on biological tissues is an increase in kinetic energy of the absorbing molecules, thereby producing a general heating in the medium. The energy absorbed by the tissues produces a temperature rise that is dependent on the cooling mechanisms of the tissue. In air, where there is no forced cooling, as in electrosurgery, the affected thermal damaged area could be as large as 1.2 mm (Chinpairoj, S., et al., A comparison of monopolar electrosurgury to a new multipolar electrosurgical system in a rat model. Laryngoscope 111(2): 213-7 (2001)) and in some cases the zone of thermal necrosis could be 0.97-1.4 mm (Duffy, S, et al, In-vivo studies of uterine electrosurgery. Br J Obstet Gynaecol 99(7): 579-82 (1992); Duffy, S., The tissue and thermal effects of electosurgery in the uterine cavity. Ballieres Clin Obstet Gynaecol 9(2):261-77).

Research has shown that the collateral tissue damage in electrosurgery can be reduced by lowering the frequency to 0.1 MHz and introducing a liquid or gel between the electrode and the tissue. (Burns, R., et al., Electrosurgical skin resurfacing: a new bipolar instrument. Dermatol Surg 25(7): 582-6; Chinpairoj, S., et al., A comparison of monopolar electrosurgury to a new multipolar electrosurgical system in a rat model. Laryngoscope 111(2): 213-7 (2001)). When an electrically conductive fluid or gel is used in conjunction with RF, the ions transfer the energy to the tissue leading to breakage of covalent bonds of the structural proteins. If an external liquid is present at the interface of the tissue-probe, a large fraction of the thermal energy will be absorbed by the liquid or gel thus reducing the thermal damage in the tissue. In this process, sometimes referred to as electro-dissociation (Chinpairoj, S., et al., A comparison of monopolar electrosurgury to a new multipolar electrosurgical system in a rat model. Laryngoscope 111(2): 213-7 (2001)), the maximal temperature can be reduced to 70-100° C. and the region of thermal damage can be as low as 20-60 μm. Thus, by improving the heat transfer conditions even at room temperature the thermal damage in electrosurgery can be reduced by a factor of 20.

There exists a need in the art for the ability to observe gene expression patterns, as well as basic tissue morphology, at high-resolution in three dimensions within complex, large blocks of tissue. An electro-sectioning system for producing thin sections (4-10 μm) of fresh (unfixed, unfrozen) tissues of a high quality suitable for histological, immunohistochemical, and gene expression (mRNA) analyses is described herein.

The various types of chemical bonds in tissue samples—covalent, ionic, induced dipole, etc—rely on electric fields to create their net attractive force. Fields from any outside source, if they are sufficiently stronger than those employed in the bonds, can disrupt these interatomic forces, resulting in bond breakage and subsequent physical separation of the atoms. This phenomenon is generally considered deleterious when materials lose their chemical and structural integrity in the presence of high fields. For instance, when the gate oxide of a CMOS logic transistor on an integrated circuit is perforated by the normally benign fields used in its switching operation, it becomes “leaky” to the current used to toggle its logic operations, possibly to the point that it can no longer respond. This “oxide breakdown” is a common failure mechanism in microprocessors, producing a sudden and irreversible loss of functionality. However, this same field-induced sub-micron cleavage may be employed as a useful tool in situations where highly-localized bond breaking is desired, such as in tissue sectioning.

While electrosurgery has been employed successfully for decades, the use of electric potential and current to cut tissue has been practiced at size scales on the order of that used in traditional surgery: mm's. The resulting region of tissue damage is, inevitably, of the same size. There is therefore a need for methods of sectioning fresh tissue while minimizing collateral tissue damage.

### BRIEF SUMMARY OF THE INVENTION

The ability to observe gene expression patterns, as well as basic tissue morphology, at high-resolution in three dimensions within complex, large blocks of tissue are needed. Prior art methodologies produce tissue sections that are altered either in architecture by ice artifacts, in molecular integrity by fixation and processing, or are too thick for high-resolution imaging. The present invention is directed at a new technique that can section fresh unfixed tissue into very thin layers (4-10 microns) with preserved tissue architecture, antigenicity, and mRNA content, that is also amenable to 2-D or 3-D computer reconstruction that can be compared with MRI and CAT scans. Electro-dissociation (also called “electro-sectioning” herein), using a focused electromagnetic field, can produce consecutive thin sections of fresh tissue for immunohistochemical and nucleic acids analyses by severing molecular bonds or structural bonds or propagating preexisting dislocations, microscopic cracks or flaws in the tissue without mechanical cutting. (As used herein, the terms “electrical field” or “electromagnetic field” are use interchangeably and are intended to refer to either an electrical field alone, a magnetic field alone, an electromagnetic field or any combination of the foregoing. The term “structural bonds” is intended to refer to any bonds that provide structural integrity to tissue and thereby hold the tissue together.) By using the techniques of the present invention, the region of collateral tissue damage can be scaled down almost without limit through the judicious design of a sectioning tool. The unique relationship between electric field strength and the resulting current to the size and specific shape of the conductive sectioning tool makes it possible to achieve very high fields over very small volumes of space. The present invention describes an apparatus and method to section tissues without mechanical force or thermal damage, thus ultimately allowing high-resolution volumetric reconstruction of gene and protein expression patterns of large tissue specimens. As used herein, the terms “sectioning” and “separating” are used interchangeably and are not limited to producing sections of tissue for analytical purposes.

Conventional tissue preparation for sectioning includes the following steps: (1) The tissue is fixed in formalin followed by processing to preserve the tissue or the tissue is frozen at −70° C.; (2) The tissue is set in wax following formalin or kept frozen; (3) The block or frozen tissue is sliced (to 2-20 μm thick slices) by mechanical means using a microtome where the typical slice thickness is 2-5 μm; (4) The slices are mounted on an electrically charged microscope glass slide; and (5) The tissue slices are chemically and/or biologically processed to reveal/highlight specific details such as cells, vessels, proteins or any antigen. The two most time consuming portions of this process are steps 2 and 4. Conventionally, step 5 has been automated to improve the accuracy and speed of the process and eliminating the requirement for a skilled technician.

The present invention is designed to section fresh tissue for histopathological and immunological examination, at room temperature, without prior processing. The tissue could be as large as a human body requiring a very large device or it could be a complete tumor or lesion for sectioning in a desktop system. The device could be applied to homogeneous tissue or heterogenous tissue (e.g., made of a combination of fat, muscle and bone). The sectioning process of the present invention could easily be automated, thereby eliminating the requirement of a skilled technician in step 2 above.

The device of the present invention is based on the concept of using an electro-discharge machine (EDM) generating an intense focused electrical field to accurately slice tissues. Thermal interaction is minimized to avoid damage to the tissue by thermal effects. Thermal interaction may be minimized by utilizing a cooling medium, e.g., submerging the tissues in liquid. The device is a modification of an “electric knife” routinely used in surgery to remove tissue. The present invention would use similar technology to minimize thermal damage to tissue. In one embodiment, the tissue removed from a patient would be placed on a holder submerged in a cooling bath comprising a liquid such as saline or water. A computer controlled EDM machine having a sectioning tool and an x-y-z translation stage would slice the tissue as defined by a predetermined program. The liquid in the cooling bath could be cooled to minimize tissue heating during cutting. Cooling may be obtained by means other than a cooling bath, for example, sprays, rapid movement of the sectioning tool through the tissue or pulsing the electric field of the conductive electrode of the sectioning tool to minimize thermal interaction time.

The sectioning tool of the present invention may employ radio-frequency or DC fields, either continuous or pulsed. To improve the sectioning action, a cooling medium, such as a bath, may include additives, for example, inorganic polar molecules or nano- or micro-sized particles that rotate under the influence of an external electrical field, or molecules that decompose and produce reactive species, such as radicals, that enhance the breaking of the molecular bonds in the tissue.

This device would enable a greater degree of flexibility in sectioning geometry, in both thickness and surface area. Furthermore, since the sectioning mechanism is through a local strong electric field that results in electrical or electrochemical etching of the tissue, we should be able to cut inhomogeneous tissues of different hardness (e.g., collagen and fat, bone and muscle, etc.) with the same instrument.

These devices could be used to make serial sections of a complete tumor or lesion that could be stained and reconstructed on a computer to provide a virtual 3-D histological image of the lesion as it was positioned in the body. By automating the sectioning procedure and doing it in liquid using an intense focused electrical field we minimize distortion of the slices since the sectioning is done through electro-erosion or electro-sectioning without physical force on the tissue. This procedure will allow the physician to visualize the tumor in the patient's body and accurately assess whether the complete tumor was removed. Furthermore, it will provide a superb resolution, at a cellular level, to view the microstructure of the tissue with reference to its location in the body. The device will enable thin sections (e.g., 2-10 μm thick) to be formed from fresh, large and inhomogeneous tissues (e.g. fat and muscles) that do not have to be previously processed and embedded in paraffin. The present inventors are aware of no other technique that allows this at the present time.

The present invention solves the following problems:

(1) Eliminates the damage caused by preprocessing of the tissue (e.g., freezing or embedding it in paraffin) required for preparing the thin tissue slice, thus allowing routine staining to be performed on an unprocessed thin slice. The staining is an absolute requirement for histopathological analysis. While ultrasound cutting can also allow cutting unprocessed tissues, the slices are too thick;, i.e., a minimum of 100-200 μm.

(2) Speeds up the process of analyzing samples taken from lesions removed during or immediately after surgery, allowing slices of fresh tissue to be stained in less than an hour. At present this can only be done with frozen tissue, but freezing may damage the tissue, and in frozen tissues cutting can only be done on relatively small and soft tissue samples (e.g., 4-10 mm cross section)—these samples could well be non-representative of the lesion they were taken from. The present invention will allow sectioning of large and even hard tissues that are much more representative of the tissue they were taken from.

(3) Allows serial sections from lesions to be obtained that can be used for 2-D and 3-D reconstructions. The current technique (microtome) allows serial cutting, but the size of the section is limited in dimensions less than one square inch and the tissue must embedded in paraffin that has to be placed in a water bath and thus will be randomly located on a microscopic slide. Moreover the microtome process is very laborious and is not automated. Automation of this process would likely require expensive robotic systems (as it is almost random), and would suffer from size limitations and all other issues that associated with using a microtome (e.g., inconsistency of slice thickness, missing slices, and inability to cut hard and soft tissues in the same specimen). The microtome was not designed for that purpose as it is routinely used to obtain a single or few slices from a specimen.

Among the advantages of the present invention is virtual reconstruction of the lesion as it was within the patient before surgery. The stained lesion slices may be reconstructed to a 2-D or 3-D object which represents the lesion as it was removed from the patient. This image may then be incorporated with a MRI image to show how the lesion was located within the patient before surgery. This capability is extremely important to determine if the abnormal tissue was indeed removed in its entirety (for malignant lesions) and to understand the growth mechanisms of all type of lesions (such as vascular lesions). To achieve that goal the lesion needs to be removed as one or two to three pieces at most. To virtually “place” the stained tissue within the patient, inert markers (such as graphite) that can be easily distinguished and imaged by MRI, ultrasound and CT may be placed presurgically within the lesion. These markers remain unchanged in the 2-D or 3-D reconstruction and may be used for locating the virtual stained tissue within the patient.

Using surface immunostaining techniques including iron or copper, the tissue surface could be imaged before sectioning and that image could be used for the reconstruction and examination of the lesion. In this case the imaging could be done with a spectrophotometer and/or lasers and high resolution digital cameras to obtain a histopathology-like micrograph.

Effective electro-sectioning of fresh, unprocessed tissue is achieved by moving an extremely localized, high-strength (e.g., 10 MV/m) electric field through the tissue. In tissue, electric fields propagate 10⁹ times faster than diffusion-limited, unwanted processes, such as thermal damage and dielectrophoresis. Tissue sectioning could be enabled without damage by limiting the electric field-tissue interaction time. Thus, a focused, high-strength electric field can break down tissue bonds without heating the tissue above 42° C., thereby eliminating thermal damage (a major concern) to tissue components. As the high-strength localized electric field of the sectioning tool passes through the tissue specimen, molecular bonds in the tissue break. This creates a sharp, well-defined plane of separation, with little or no damage to the immediately adjacent tissue. The absence of damage is assured by i) a short interaction time, ii) heat extraction toward the working electrode, and iii) active cooling at 2 to 5° C. (above freezing). In electro-sectioning, thermal and electrochemical damage (i.e., collateral damage) can be subdued by limiting both the effective interaction time and the volume of the high strength electric field.

The sectioning tool separates tissue but no mechanical cutting is involved. The extended electrode of the sectioning tool is designed to produce a highly focused electro-magnetic field capable of also sinking thermal energy away from the electrode/tissue interface.

The field strength that can be tolerated before an otherwise insulating material breaks down and loses its original structure has been studied for over two centuries, since this behavior elucidates some of the fundamental electrical structure of dielectrics. For most insulating materials, from inorganics to polymers to biological tissues, the theoretical, or “bulk value,” of the breakdown field is rarely achieved—a much smaller breakdown field is normally exhibited, which is advantageous to this invention. This is because when a thin material has a voltage impressed over it, breakdown occurs first at defects and then spreads by avalanche mechanisms to create a general breakdown. Materials having defects as small as crystal dimensions are more conductive than materials without defects, and they allow the passage of current first. The resulting highly localized heating decreases the binding force of electrons in the area, enabling them to be ripped away and accelerated by the field. Generalized breakdown then occurs when these accelerated electrons reach sufficient velocity to knock other electrons out, creating the avalanche effect. The result is a loss of organized structure because the broken bonds will randomly re-form with the closest available unsatisfied bond, which will rarely be the same one that was broken, and because volatile breakdown products may be ejected from the area. For most inorganic materials, 100-2,000 MV/m is a realistic range of the breakdown field. Organic materials, such as polymers, breakdown at lower values of around 5-100 MV/m. The breakdown threshold is lower for organics because they have more covalent bonding as opposed to the ionic nature of atomic interactions in inorganics, such as ceramics. Biological tissue would be expected to break down over a wide range that would correspond to the lower end of the polymer's range, around 5-40 MV/m.

Collateral damage is defined as the deleterious aspect of interactions with the tissue, and that may include the desired tissue sectioning mechanism operating outside the intended boundaries. Certainly, the first place to look for background on this subject is the considerable amount of literature on electrosurgery. In the conceptual scaling down of the geometry of the typical electrosurgical working electrode, various damage mechanisms will scale differently, and it is this inequality that we are taking advantage of to create conditions for sectioning tissue with insignificant collateral damage. The closest analog in traditional electrosurgery is fulguration, which is also a unipolar method but requires voltage sufficiently high to frequently create a spark due to the breakdown of tissue and/or air in the vicinity of the working electrode. The voltages used in the present invention may approach those used in fulgurative treatments, but because of the combination of a vastly reduced working-electrode area and the field-concentrating shape of the blade edge, the damage area is expected to be acceptably localized and confined to the area to be separated.

High-strength field disruption of covalent bonds occurs in time scales of <1 μsec, so this should not be a limiting factor in setting the rate of sectioning. Cutting speeds during electrosurgery are on the order of 0.25 cm/sec, and rates in this range should be achievable by the present invention. If the high-strength-field zone achieves effective bond scission over a distance of 1 μm from the sectioning tool edge, an expected typical value based on field modeling, then the residence time of tissue in the cutting zone would be 0.4 msec, providing sufficient time for field-induced bond scission and material separation. In addition, the length of time in the cutting zone will not be long enough for significant tissue heating because heat spreading from such a small volume would be very fast and because of the heat-sinking properties of the sectioning tool in intimate contact with the tissue.

The migration of ionic species under the expected high-strength-field conditions has the potential to cause various sorts of localized damage, such as denaturation of proteins, drag-through damage to cell walls, and bubbling due to oxidation or reduction of mobile, charged species. For instance, at high DC current levels, asynchronous depolarization of the cardiac tissues can result in fibrillation due to depletion of ions through cell walls. In living tissues, this sort of damage can be temporary, but in pathology samples, there will be no mechanism to re-establish the proper ionic distribution across cell walls, which might result in undesirable distortion of the tissue microstructure.

The required field in the sectioning zone may be on the order of 10⁷ V/m=10⁵ V/cm, so the migration speed of an ion, such as K⁺, in the high-strength-field zone in tissue would be on the order of 10 cm/sec. As the 1 -μm sectioning zone moves at 2.5 mm/sec, the time the tissue sees this high-strength field is, again, 0.4 msec, in which time the ions would move about 40 μm. This worst-case calculation is many times the extent of the sectioning zone, but there are two factors that prevent this from causing damage over that extent. First, the field may be localized to a great extent by the shape of the sectioning tool such that, within about 6 μm, the field falls to about one-tenth its sectioning level. In this field, the ion would move only 4 μm in the sectioning residence time, so the total area affected by ionic migration should be confined to a distance of no more than about 10 μm from the edge of the sectioning tool. This factor is minimized if the voltage waveform is not DC, but rather either sinusoidal AC or some form of square wave, which would equivalently consist of many high-frequency sinusoidal components to add up to the more angular voltage waveform. A field reversal of only 100 kHz during sectioning would only cause the ions to oscillate within a fraction of a micrometer about a fixed position.

Bubble formation from either oxidation or reduction of solution-borne species is due to the local voltage, not the field, and these required potentials are only on the order of a few volts. Because the expected working voltages should be on the order of 10-100 V, the electrochemical reactions that produce bubbling will only occur at the electrode surface and not in the bulk material, and because the sectioning tool will move through the tissue, there will be no accumulation of gases. Gas production will be limited by the availability of oxidizable species. As indicated in the above analysis of ionic motion, ionic species, such as chloride, proton, and hydroxyl, are not expected to be sufficiently mobile under alternating-field conditions to create sufficient flux to the electrode for significant gas production. However, it is expected that any local water can and will be dissociated into hydrogen and oxygen gas by the AC voltage waveforms. Because the exposed conductive surface area is very small, there will be relatively little gas production compared with that in traditional electrosurgery—another scaling benefit. While not totally avoidable, it may also be beneficial as a mechanical mechanism to separate the newly sectioned tissue faces. There will also not be an appreciable change in local pH because by the use of alternating current; equal amounts of proton and hydroxyl will be produced on alternating cycles.

Dielectrophoresis is expected to be operative only on small, mobile, charged species, such as sodium and potassium ions. These will be removed through the cell walls in well under a millisecond, resulting in some local degradation of membranes due to electroporation. As with most damage mechanisms, this will help sectioning if it is not too extensive. Denaturation will be operative for large biological molecules and should aid the sectioning process.

Hence, by limiting the electric field-tissue interaction time to <0.4 msec, collateral damage can be avoided.

The effectiveness of the invention may be enhanced through various alternative embodiments. For example, media such as inorganic polar molecules may be added to a cooling bath in which the sectioning tool and tissue sample are immersed to improve sectioning via molecular rotation produced by an external electric field. The sectioning action is enhanced by specific sectioning tool design to create a more intense and localized field. As an alternative cooling mechanism, the buildup of heat may be limited by pulsation of the field. Whereas, in tissue, the electromagnetic field propagates six orders of magnitude faster than the thermal field, high electromagnetic fields can be induced for short times to break structural proteins bonds without thermal damage. Similarly, DC pulses rather than radio frequency (RF) pulses may be used to achieve tissue sectioning while minimizing heat buildup.

The device may be adapted to uses other than sectioning tissue for analysis purposes. The device may be adapted to do minor surgery where the pulses are sufficiently short (microseconds) that the field behaves like an RF field without affecting the nervous system adversely. The present invention offers substantial safety benefits, both in surgical and non-surgical applications. Microtomes and similar devices physically touch tissue and therefore can become contaminated. The present invention does not section tissue by direct mechanical action and therefore has less potential to contact and become contaminated by pathogens in the tissue. Furthermore, the intense electric field strength associated with the device will limit the viability of organisms in its vicinity. Additional protection may be obtained by circulating liquid in the cooling bath through sterilizers.

It is therefore an object of the present invention to provide for a device and method capable of producing ultra-thin sections of large, unfixed tissue specimens.

It is a further object of the present invention to provide for a device and method of producing ultra-thin sections of large, unfixed tissue specimens with preserved tissue architecture, antigenicity and mRNA content.

It is a further object of the present invention to provide for a device and method of producing ultra-thin sections of large, unfixed tissue specimens that are amenable to 2-D and 3-D molecular analysis.

It is a further object of the present invention to provide for an alternative device and method to intraoperative frozen section diagnosis.

It is also an object of the present invention to provide for a device and method for sectioning of fresh, unprocessed specimens of large size, thus allowing rapid intra-operative evaluation of the surgical margins of an entire resected tumor specimen, without the need for regional sampling.

It is also an object of the present invention to provide for a device and method for sectioning of fresh, unprocessed specimens of large size without compromising the sections by ice artifacts.

### BRIEF DESCRIPTION OF THE DRAWINGS

These and other features, objects and advantages of the present invention will become better understood from a consideration of the following detailed description and accompanying drawings in which:

FIG. 1A shows a cross-sectional elevation view of an embodiment of the present invention in which the sectioning tool is a blade having an electrode within a multi-layered structure.

FIG. 1B is a partial elevation view of a tissue sample on the tissue holder of the present invention.

FIG. 1C is a plan view of an embodiment of the invention where the sectioning tool is an electrode comprising a taut thin wire.

FIG. 2 shows an elevation view of an embodiment of the present invention.

FIG. 3 is a cross-sectional elevation view of an embodiment of the sectioning tool of the present invention, wherein the sectioning tool comprises a thin blade having a unipolar electrode. The blade is shown with an electrode having a radiused edge and there is a remote ground electrode.

FIG. 4 is a graph of the electric field decay, as a function of the distance from the edge of the blade for different radii of the electrode as calculated for a 100 V bias with a ground electrode 10 cm away from the edge.

FIGS. 5A-E are cross-sectional elevation views illustrating a method of making the blade of the present invention using photoresist techniques.

FIGS. 6A-B are graphs showing the electric field and temperature, respectively, during 0.1 ms repeating pulses with 50 ms intervals.

FIG. 7A is a plan view of a substrate with an array of blades formed thereon.

FIG. 7B is a cross-sectional elevation view of one of the blades of FIG. 10A taken through the line 7B-7B of FIG. 7A.

FIG. 8A shows the electrode of FIG. 7B having an added layer of insulation in the form of 0.5 microns of benzocyclobuten (BCB).

FIG. 8B shows the blade of FIG. 8A with the right side ground away to form the edge.

FIG. 8C is a plan view of the blade of FIG. 8B.

FIG. 9 is a graph of the electric field at the tip of the electrode.

### DETAILED DESCRIPTION OF THE INVENTION

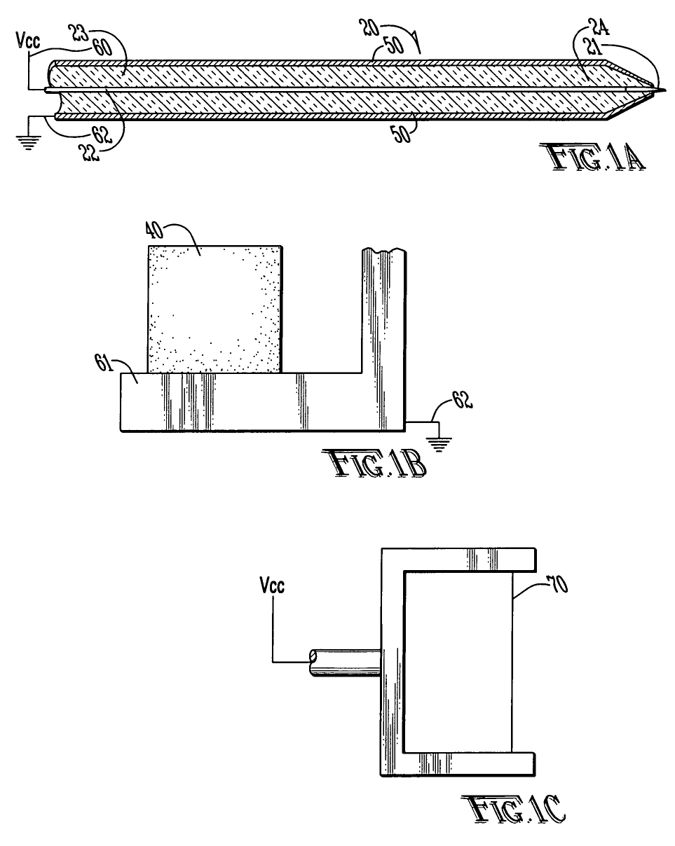

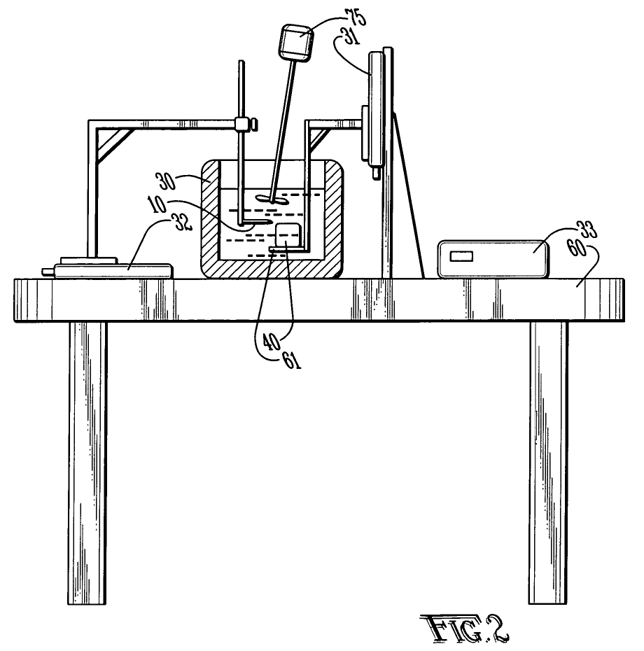

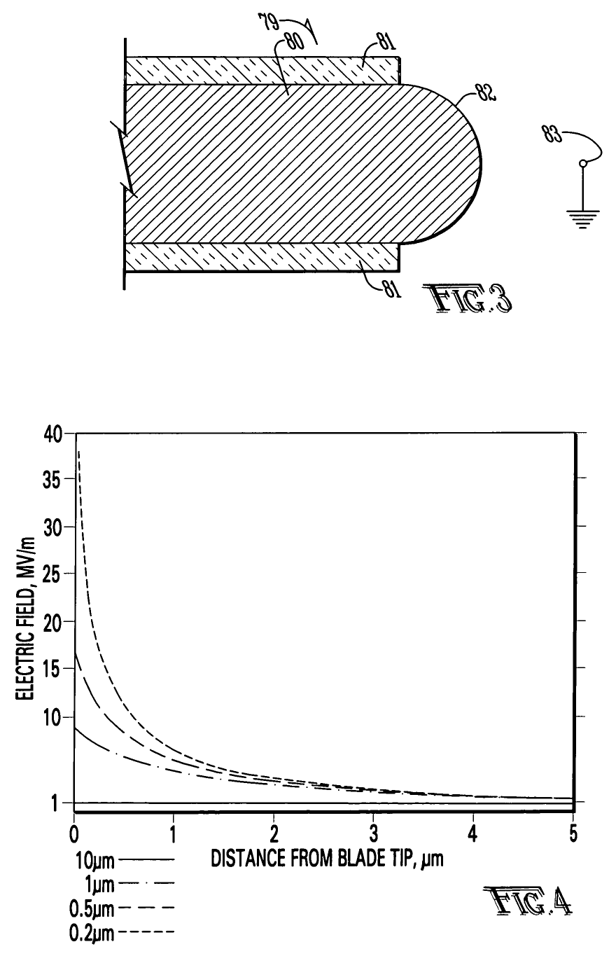

With reference to FIGS. 1A-C and 2, the preferred embodiments of the present invention may be described. The present invention is directed to satisfying the need to produce thin (4-10 μm) serial sections of large fresh tissue specimens that are suitable for high-resolution in situ protein/gene expression studies without ice artifacts or fixation-induced molecular damage.

Limitations of the existing sectioning techniques result from the fact that they rely on mechanical cutting, which in turn requires the tissue to be rigid. The present invention is a new approach to section tissue via an electro-sectioning process. In one embodiment, the sectioning tool is electrically biased with respect to the tissue sample which is submerged in a cooling bath. The sectioning tool may use focused radio frequency (RF) energy or pulsed DC. The present invention is directed to a method of using electro-sectioning to produce consecutive thin sections of fresh tissue for immunohistochemical and nucleic acids analyses without mechanical or thermal damage, ultimately allowing high-resolution reconstruction of gene and protein expression patterns of large tissue specimens. Since the method and apparatus of the present invention uses electro-sectioning rather than ablation to section tissue, thermal damage is minimized.

Sectioning without mechanical pressure minimizes deformation of soft tissue specimens that are held in position during the sectioning procedure. Therefore, the present invention is directed at using an electric field to section tissue samples. The electric field will be directed using a sectioning tool 10 where the electric field is preferably highly focused at the sectioning edge, although some applications may permit a lower degree of focusing. Focusing of the electric field is accomplished by using a sectioning tool 10 with a thin structure such that the energy is concentrated on a thin edge, e.g., a taut small diameter wire 70, or by using a blade 20 in which the electric field is focused at the edge 21 of the blade 20. As shown in FIG. 1C, the wire 70 is preferably small in diameter to produce a narrowly focused field. A suitable diameter would be around 0.2 mm, although the invention is not limited to this wire size. The multi-layered structure of the blade 20 as described below also serves to focus the electric field at the narrow leading edge 21 of the blade 20. The electric field will reach its maximum intensity at the tissue-blade interface, dissipating very rapidly away from this interface. However, as previously described, RF energy can cause thermal damage to the tissue. To eliminate heating or thermal damage, in one embodiment the tissue will be cooled without freezing by submerging it during the sectioning process in a liquid cooling bath 30 containing cryoprotectants as necessary. If the temperature of the cooling bath is 0° C. or below, cryoprotectants would be required; otherwise, if the temperature is above 0° C., cryoprotectants are not required. The cooling bath 30 may be cooled by any of a variety of refrigeration means (not shown) that would be apparent to one of ordinary skill in the art. Further, the cooling bath 30 may include a stirring apparatus 75 to stir the cooling liquid to dissipate both heat and dissociated molecular components from the tissue in the vicinity of the sectioning tool 10. The cooling bath 30 provides a relatively large “sink” to accept dissociated ions from the tissue sample 40 and to avoid the buildup of a high gradient of dissociated ions in the vicinity of the sectioning tool 10 and tissue sample 40. The cooling bath 30 may comprise any of various liquids, such as a water, saline, buffered saline, silicone oil, etc. The liquid may be either an electrolyte or a non-electrolyte.

The field of sectioning will be confined to a very narrow region (a few microns) by delivering the energy to the tissue via a thin wire or a very fine multi-layered blade 20. The multi-layered blade 20 can be produced using thin film technologies such as physical or chemical vapor deposition. Other techniques may be used to form a thin electrically conductive edge in a non-conductive material. For example, a non-conductive material may be doped along a narrow region to form a thin electrically conductive electrode within non-conductive regions. In one version of the invention, the tissue sample 40, either directly or through the tissue holder 61, is connected to a return electrode as shown in FIG. 1B. More generally, the sectioning tool 10 must be biased electrically with respect to the tissue 40. Although RF is the preferred form of electrical field for providing the electro-dissociation of the tissue 40, the field associated with the sectioning tool 10 may be AC or DC and the frequency is not limited specifically to RF. As the blade 20 is passed through the tissue specimen, molecular bonds in the tissue will be electro-dissociated or severed so that the release of dissociated ions will create a sharp, defined plane of section. In electro-sectioning, individual ions are separated from the bulk of the tissue sample without putting mechanical stress on the tissue. Electro-sectioning allows harder tissues such as bone to be sectioned easily, unlike prior art methods that require significantly greater mechanical force to section bone than more easily sectioned tissues such as fat and muscle.

Active cooling of the liquid cooling bath 30 and precise focusing of the electric field at the edge 21 of the sectioning tool will minimize thermal damage to the tissue. For example, the electric field could be an electromagnetic field and the frequency could include 100 kHz with the current density less than 0.1 A/cm² where tissue temperature will not exceed 38° C. during the process. By combining these two techniques of cooling the tissue in a cooling bath and narrowly focusing the electric field, tissue can be cut by electro-sectioning while eliminating thermal damage and limiting the energy absorption to a submicron region. This will allow consecutive production of ultra-thin (4-10 μm) tissue sections that can be captured on glass slides for histological, immunohistochemical, and nucleic acid analysis.

One embodiment of the present invention would drag a very thin, taunt wire 70 carrying current, e.g., RF current, through the cooled tissue in an X, Y plane, producing a thin plane of tissue electro-dissociation in the path of the wire 70. The plane of the motion of the wire 70 will be positioned precisely parallel to a positively charged glass slide (not shown) positioned on the surface of the tissue specimen 40. Thus the released section, being negatively charged, will stick to the slide, and the slide containing the sliced section will be pulled mechanically away from the tissue specimen 40 and retrieved for staining and analysis. Another slide would then be positioned on the surface of the tissue specimen 40 and the process repeated.

The relative positions of the glass slide and wire in X, Y, and Z axes is precisely controlled by a motorized linear translation stage and appropriate fixed supports. For example, and not by way of limitation, a vertical translation stage 31 may be used to move the tissue specimen 40 in a vertical or Z axis direction, while a horizontal translation stage 32 may be used to move the sectioning tool 10 in a horizontal plane including the X and Y axes. The motion of the vertical and horizontal translation stages 31, 32 are under the direction of a computerized motion controller 33. Variables related to the slide include the amount of pressure applied to the slide against the tissue specimen 40 in order to achieve adhesion without distortion, the type of positively charged coating on the slide, or use of a conductive metal “slide” followed by transfer of the section to glass for microscopy.

Another embodiment of the present invention uses thin film technology to produce a rigid blade 20 that will pass through the specimen 40, sectioning by electro-dissociation at its leading edge 21 where the electrical field, e.g. RF energy, is to be focused as shown in FIG. 1A. The leading edge 21 is electrically connected to an electrode 22 and may be made from a stainless steel or titanium razor blade. The blade 20 may be formed by masking the edge 21 of the blade 20 to prevent deposition of metallic and insulator layers at the edge 21. This central electrode 22 is then coated with a sandwich of insulator 23 such as benzocyclobutene (BCB) at 5 to 10 microns in thickness on each side of the electrode 22 followed by a biocompatible electrically-conductive alloy 50 such as platinum/silver alloy. In operation, the electrically-conductive alloy 50 is electrically connected to ground and serves to focus the field on the edge 21. The final step of forming the blade 20 is to selectively etch the insulator 23 into a sectioning shape 24 at the leading edge 21 of the blade 20 using a laser or electron beam in a high vacuum system.

The coatings 23, 50 will terminate about 200 μm from the edge 21, exposing the sharp metal of the electrode 22 to the solution, where the electric field 60 will be transmitted to the liquid medium of the cooling bath 30 and the tissue specimen 40. This will result in focusing the electric field 60 at a very narrow region between the edge 21 of the blade 20 and the tissue specimen 40. There will be no direct physical contact between the sharp edge 21 and the tissue specimen 40 as the blade 20 passes through the specimen 40 since the molecules of the tissue specimen 40 will be electro-dissociated or severed as the tissue specimen 40 is approached by focused electric field at the edge 21 of the blade 20, although the tissue may touch the upper or lower part of the blade. Through proper materials selection and blade design it is anticipated that the electric field may be focused to a few micrometers at its thin edge 21.

The geometry of the blade 20 is designed specifically to focus the electric field 60 while providing a rigid, thermally conductive surface 50 that can be used to lift up the tissue section after sectioning and help to extract any heat generated from it. As the blade 20 passes through the tissue specimen 40, a well-defined region of arc will be created between the blade 20 and the tissue specimen 40, which will lead to sectioning or electro-dissociation of the tissue and the flow of ions from the tissue to the solution in the cooling bath 30. In the preferred embodiment, the electric field is an RF field.

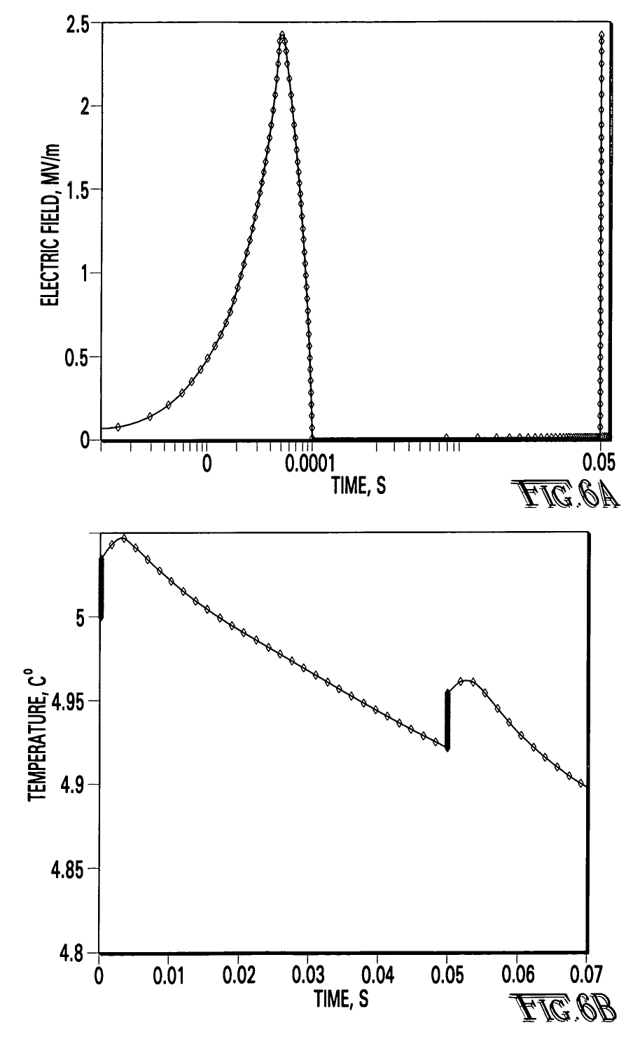

FIGS. 6A-B show the electric field and temperature, respectively, during 0.1 ms repeating pulses with 50 ms intervals.

As with the embodiment of the moving wire, the motion of the electric field 60 will create a plane of tissue dissociation causing release of a fine layer of tissue (a “section”) from the bulk of the tissue specimen 40. The thickness of the section will be controlled, as with the wire method, by control of the position of the blade 20 relative to the surface of the tissue specimen 40 in the z-axis during successive passes of the blade 20. Only the external metallic coatings 50 on the flat sides of the blade 20 will be in contact with the tissue as the blade 20 moves forward. There will be no physical contact between the sharp edge 21 and the tissue specimen 40, since the sectioning mechanism is not mechanical cutting, but rather based on electro-dissociation. The stiffness of the blade 20 will ensure a smooth plane of sectioning as well and allow lifting up of the section onto the flat surface of the blade 20 after sectioning.

The power supply for the cutting system could include a signal generator and broadband amplifier (not shown). The input energy is desirably obtained from a RF generator capable of delivering 300 watts of power. The frequency could be varied in the range of 10 kHz to 15 MHz. To achieve this a synthesized function generator (Stanford Research Inc., Sunnyvale, Calif.) and a broadband power amplifier (M404E RF power amplifier, Bell Electronics NW, Inc. Renton, Wash.) are anticipated to function acceptably. It is well known that frequencies in the 100 kHz range have been found to cause minimal damage in prior studies on electrosurgery. (Burns, R., et al., Electrosurgical skin resurfacing: a new bipolar instrument. Dermatol Surg 25(7): 582-6; Chinpairoj, S., et al., A comparison of monopolar electrosurgury to a new multipolar electrosurgical system in a rat model. Laryngoscope 111(2): 213-7 (2001)). As an example, other frequencies, such as the 490 kHz region which is easily obtained using available electrosurgical devices, may be used.

To achieve precise cutting and positioning, linear translation stages (M-ILS250CC and M-ILS250CCHA) available from Newport Corp, Irvine, Calif. are anticipated to perform acceptably in conjunction with a flexible digital controller (Newport, ESP7000-opt-02-01-nn-nn-n-01-n) available from Newport Corp, Irvine, Calif. The vertical translation stage 31 will adjust the height of the tissue specimen 40 relative to the sectioning tool 10, either the taut wire 70 or the blade 20, thereby controlling slice thickness. A DC motor driven stage incorporating linear encoders or a micro-stepped motor driven stage will offer specifications suitable for this application.

The horizontal translation stage 32 may be used to actuate the sectioning tool 10. A DC motor driven stage is desirably capable of providing a constant travel velocity. The velocity of the stage will need to be variable and capable of relatively rapid motion. A rotary encoder available from Newport, M-ILS250CC, would be acceptable for feedback control since absolute position will not be critical along the horizontal plane. The control electronics should be selected to fulfill the following four requirements: stage compatibility, stand alone point to point control, expandable and programmable for future automation requirements.

The translation stages 32, 31 are desirably mounted to an optical breadboard table 60 of the type available from Newport Corp., Irvine Calif. (VH3048W-OPT-25-NN-NN-NN-01-N-N-N-N-N-N-N) or a similarly rigid and easily used surface for stage mounting flexibility.

The tissue specimen 40 is desirably held in place by with a room temperature histomer such as that available from Histotech, Egaa, Denmark. The histomer is a room temperature polymerized agar base polymer that has been used to align tissue for cutting, without penetrating it (Bjarkam, Pedersen et al. 2001). Alternatively, the tissue specimen 40 can be floated with one face attached to a stage. As a further alternative, the tissue specimen 40 may be held in place by a polymer bag which is shrunk onto it so that the polymer bag becomes rigid at the operating temperature of the apparatus through the glass transition phase of the polymer with no heat involved. The tissue 40 is desirably submerged within a buffered isotonic saline cooling bath 30 at pH 7.4 and containing 10-30% glycerol at 2 C. The tissue specimen 40 is placed on a tissue holder 61 that in turn is connected to the return electrode 61. The temperature of the cooling bath 30 is desirably 2±1° C.

In an alternative embodiment of the present invention, the design of the sectioning tool was optimized for a blade 79 having an extremely thin conductor 80 sandwiched between two insulating layers 81 to produce a small intense electromagnetic field. Such a blade 79 as shown in FIG. 3 may be constructed by deposition of a conducting layer (e.g. platinum, Ag, gold, doped Diamond like carbon or even ceramic RuO₂) a few nanometers thick using well known thin film vapor deposition techniques. The gold has the added advantage of being a good thermal conductor.

By understanding the various mechanisms of surgical electrocutting, those electrophysical processes that control the largest extent of collateral damage can be reduced in size. When an electric knife or scalpel is utilized in tissue cutting, the actual severance is accomplished by two mechanisms: field-induced bond disruption and Joule heating. The latter of these two is the less selective; the passage of current produces local heating in the amount of:
heat in W/m³=i²ρ=i²/σ
where:

i=local current density, A/m²

ρ=resistivity, Ω-m

σ=material conductivity, Seimens/m

The collateral damage from cutting by Joule heating can be reduced by shrinking the exposed portion of the blade 79 but, below some critical size, the damage region will cease to shrink. This is because, as the size of the tool is made smaller, the region of the highest current density does become smaller, but since current is conserved, it does not diminish in other regions. Therefore, tissue sectioning by Joule heating cannot be scaled down effectively enough.

However, direct scission of bonds can be accomplished in a more localized fashion by employing high local fields to disrupt them directly, and the extent of damage from this mechanism can be scaled down almost without limit. High static or dynamic electric fields, on the order of 10⁸-10⁹ V/m, are sufficient to cause direct disruption of atomic bonds without the passage of current and the associated, undesirable heat.

The amount of field that can be tolerated before an otherwise insulating material breaks down and becomes conductive has been studied for over two centuries, since this behavior elucidates some of the fundamental electrical structure of dielectrics. For most insulating materials, from glasses to undoped Si to biological tissues, the theoretical, or “bulk value,” of breakdown field is rarely achieved—a much smaller breakdown field is normally exhibited. This is because, when a material of at least some mm's in extent has a voltage impressed over it, breakdown occurs first at defects, then spreads to create a general breakdown. Materials having defects as small as crystal dimensions are more conductive than materials without defects, and they allow the passage of current first. The resulting highly-localized Joule heating decreases the binding force of electrons in the area, enabling them to be ripped away and accelerated by the field. Generalized breakdown then occurs when these accelerated electrons reach sufficient velocity to knock other electrons out, creating an avalanche effect leading to large breakdown currents. For most inorganic materials, 100-200 MV/m is a realistic range of breakdown field, while defect-free single crystals of the same materials can tolerate an order of magnitude more.

Conceptually scaling down a standard electrosurgery cutting blade illustrates how the two mechanisms change and how field-induced sectioning can be optimized for very small amount of damage during tissue sectioning. The sectioning blade will start with a standard piece of polished stainless steel 1 cm in length and 3 mm in width. The other electrode, at ground potential, would be at least some several cm's away with a large-area attachment to the patient, such as a thigh or back pad.

DC potential on the blade produces both a localized high-field volume and localized current density. The latter results in poorly-controlled tissue heating, as well as other modes of damage such as desiccation and ion removal. However, even 100 V of potential would not lead to a field of sufficient strength near the blade to cut by direct bond scission.

As the electrosurgery blade is scaled down, the area of conductor exposed to tissue is reduced, which decreases the electrical current and, consequently, Joule heating. However, at the same time, the local high field at the blade edge becomes both stronger and more highly localized. The state of this field is determined by both the size and the geometry of the sectioning edge. The edge does need to be sharp, but not for the purpose of physically cutting. Indeed, mechanical cutting is to be avoided in this application due to the unacceptable amount of tissue damage it can inflict. The sharp edge serves to increase and concentrate the field strength since it represents a higher degree of spatial curvature.

The ideal blade for electro-sectioning would have a very small area of metal exposed and that part that is in contact with the tissue would be very sharp. This is the same reasoning behind sharpening lightning rods to increase the attractive field around them. While it is possible to draw a sharp edge as the convergence of two straight lines, it's practically impossible to actually create such an edge—they always have a non-zero radius. In fact, if such a perfect edge could be made, the local field would be infinite since this sudden edge represents an electrical singularity. The sharper and more sudden an edge that can be manufactured, the better it will be for electro-sectioning of tissue samples. It will exhibit higher strength and smaller-sized electric fields and lower amounts of undesirable Joule heating. This edge does not do physical work, since a mechanical cutting procedure is not desirable here, so various non-mechanical methods can be utilized for producing edges that could not even support physical cutting.

As an example of these trends, consider a case in which the field size and strength as well as the current levels can be derived analytically. For this case, a blade 79 with a cylindrically-radiused edge 82 as shown in cross-section in FIG. 3 will be employed. The entire assembly is insulated with a insulator 81 such as a polymeric coating except for the radiused blade edge 82. The width of the blade 79 out of the page is W and the blade edge radius 82 is R_{b}. The grounded counterelectrode 83 is off to the right by many times R_{b}, say at a distance R_{g}.

This is then a highly unbalanced unipolar configuration, with the powered electrode 80 having a blade edge 82 with a very small radius and the grounded electrode 83 being very large and located at a distance away that is many times the size of the blade geometry. The actual blade shape will be similar to this but will probably not be symmetric. This case is useful because it is close to the actual shape and can be solved analytically in order to demonstrate the competing effects involved.

Since the blade edge 82 is one-half of a circle and the grounded electrode 83 is many radii away to the right, the voltage fields and resulting currents can be modeled analytically in a cylindrical geometry for an isotropic, homogeneous conductive medium (tissue), with the origin located at the center of the radius of the blade edge 82.

Solving the differential equation that describes the electric field, where V is the local value of the voltage, r is the distance from the origin (R_{b}=0), and the following two boundary conditions apply:
1. at r=R_{b}, V=V_{b}
2. at r=Rₑ, V=0, ground potential

The electric field is given by:
dV/dr=V_{b}/(r ln(Rₑ/R_{b}))

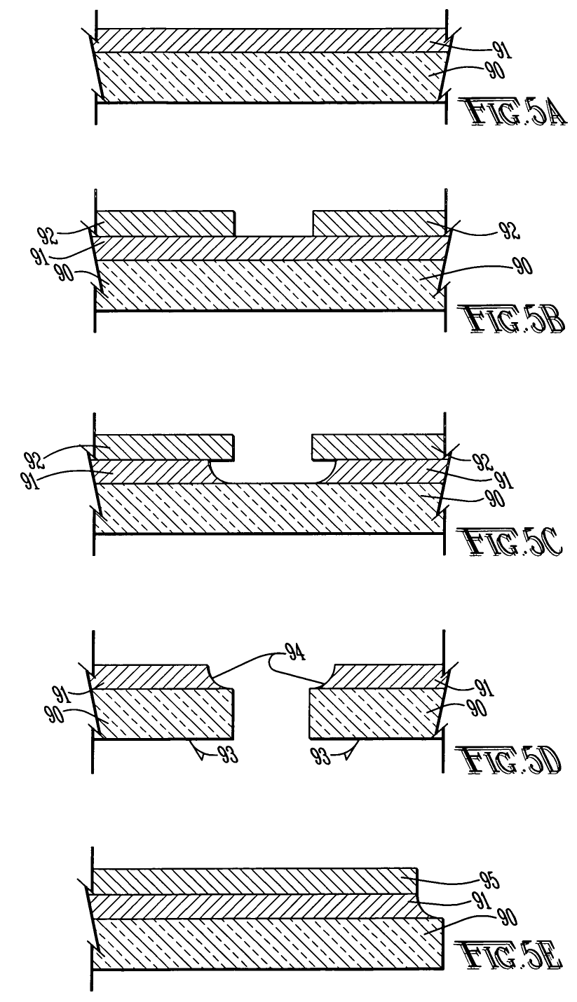

Note that neither the local potential nor the field is a function of the conductivity in a homogeneous, isotropic material. They are only a function of the total impressed voltage and the electrode geometry, and both of these can be readily controlled. With the substitution of reasonable values for voltage (−100 V) and blade radius of curvature (0.2-10 μm), the change in the electric field as a function of the distance from the blade 79, calculated as shown in FIG. 4, indicates that very high-strength fields are achieved near the surface of the blade 79, and diminish rapidly with distance. This phenomenon enables a small volume to actually do all the sectioning, reducing damage to nearby tissues. An advantage of this approach is that the reduction in blade geometry that yields the local high-strength fields also results in a lower total current, along with a reduction in deleterious joule heating.

The total current, I, is:
I=V_{b}σπL/(ln(Rₑ/R_{b}))
where σ is the electrical conductivity.

For a typical tissue conductivity of 0.10 S/m and a blade width of 1 cm, the total current drawn is only 27 mA. Multiplying by 100 V gives the total joule heating of 2.7 W. The typical specific heat capacity of tissue is C_{P}=3,600 J/kg/° C. and assuming that there is no heat exchange with the environment (worst-case scenario), the temperature increase (ΔT) per kilogram of tissue within 0.4 msec is given by ΔT=(2.7*4*10⁻⁴)/3600=3·10⁻⁷° C.·kg. Hence, if a 1-μm-thick tissue section is exposed to a blade surface of 10×5 mm (i.e., 50 μg, assuming typical tissue density of 1,100 kg/m³) at a 100-V bias, the increase in temperature due to intrinsic joule heating of the tissue will be about 5.5° C.

To calculate the electric and temperature fields in a complex geometry that matches this electrode design, we solve the electric-field and heat-transfer equations numerically.

TABLE
Dielectric and Thermal Properties of Tissue,
Blade Material and Liquid Bath

| Medium/Property | Tissue | Blade (Cu/Silica) | Bath |
|---|---|---|---|
| σ, S/m | 0.15 | 6 × 10⁷/10⁻¹⁴ | 0.1 |
| K, W/m/° C. | 0.5 | 400/1.38 | 5 |
| ρ, kg/m³ | 1100 | 8700/2200 | 1100 |
| Cp, J/kg/° C. | 3600 | 385/703 | 3000 |

Applying the following boundary and initial conditions:
Bath/environment: ground V=0; interface temperature T_{inf}=5° C., and heat transfer coefficient h=2,000 W/° C./m².
Tissue/bath: continuity; with T_{inf}=5° C. and h=3,000 W/° C./m².
Blade/bath: current source I=0 and h=3,000 W/° C./m².
Blade tip/bath: V=100 V and h=3,000 W/° C./m².
Initial bath/blade and tissue (soaked in bath): temperature T₍ₜ₌₀₎=5° C.

Given the electric and thermal properties of blade material and tissue as given in the Table above, the electric field at the edge of the electrode and the corresponding temperature can be calculated.

In these calculations the radius of curvature was 0.5 micrometer and the electric field was calculated by placing an electrode within a heterogeneous tissue. At time t=0 (t=10⁻¹⁰ sec) a 100 volts DC pulse is applied for 0.4 msec. The electric and temperature fields were calculated using the boundary and initial conditions described above. Since the electric field is extremely local and confined to the edge of the electrode, the electric field profile was plotted by a line scan from A to B as shown in FIG. 9. The electric field reaches a maximum of 20 MV/m and exceeds 10 MV/m within 1-2 micrometers while dropping to a tenth of its maximum about 5 micrometers away from the edge. At the same time the temperature field is much more diffuse. At 0.4 msec, the maximum temperature is 22° C., well below the temperature (42° C.) that could even begin to cause thermal damage. The slow rise of the temperature in comparison to the electric field is due to the low thermal diffusivity in comparison to the speed of electromagnetic propagation in tissue. This differentiation enables damage-free electro-sectioning.

As shown in the preceding electromagnetic and thermal modeling, the size, shape and configuration of the electrode 80 can be employed to simultaneously increase the local field strength and minimize the thermal effects. Several physical aspects favorably affect this simultaneous improvement of two seemingly opposed phenomena, and some of these are summarized below.

The electric field propagates through tissue at the speed of light divided by the square-root of the tissue's dielectric constant, which gives approximately 40 million meters/sec. But the thermal effects propagate through tissue due to a diffusive mechanism that relies on mechanical collisions—albeit very tiny ones. As a result, heat diffuses many orders of magnitude slower. The molecular bonds can be broken instantaneously, via the electric field, as the electrode 80 moves past the tissue site long before the thermal gradient can reach damaging levels.

From the above analyses, it is clear that the blade 79 must be thin and have a very small radius of curvature at the exposed edge 82. If it is not a perfect radius, it should be a shape that is as sharp as possible, keeping in mind that mechanically sharpened edges are far from an idealized intersection of lines and will be much more like a curve.

One way to increase the local field would be to form the edge 82 by a non-mechanical process, such as those used in forming patterns in modem microelectronics. The following is one such possibility as illustrated in FIGS. 5A-5E:

As shown in FIG. 5A, start with a thin glass or insulating Si wafer 90, then sputter with about 1 micron of Cu or some other conductor 91.

Coat with photoresist 92 and open a window about 0.1 mm long as shown in FIG. 5B.

Immerse in an isotropic Cu etchant such as FeCl₃ or a sulfuric acid solution. The resulting etch pattern will be as shown in FIG. 5C.

Strip the photoresist 92 and cut the resulting two blades 93 apart as shown in FIG. 5D.

The result is two blades 93 with almost atomic sharpness since the edges 94 are formed from chemical etching, rather than from mechanical grinding. The glass forms the support for the thin layer, and this can be thinned down to decrease the height of the entire assembly, and a second cover glass 95 can be added to the top of the blade 93 as shown in FIG. 5E.

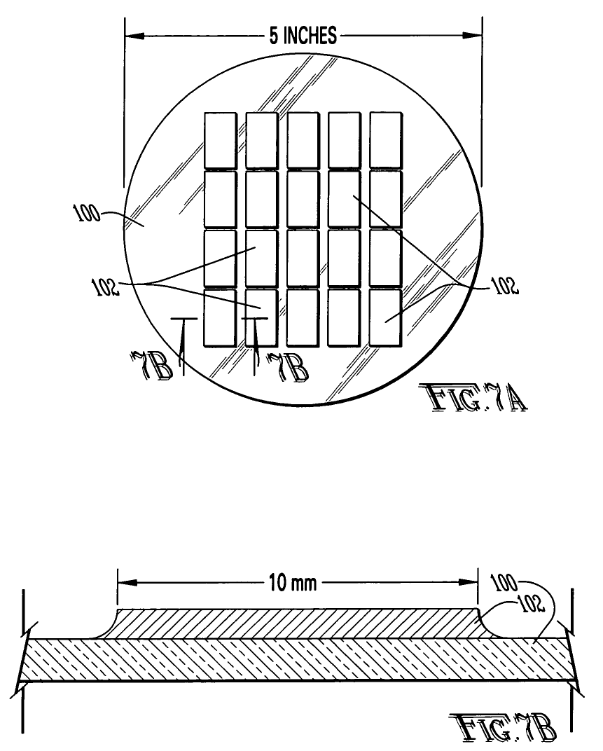

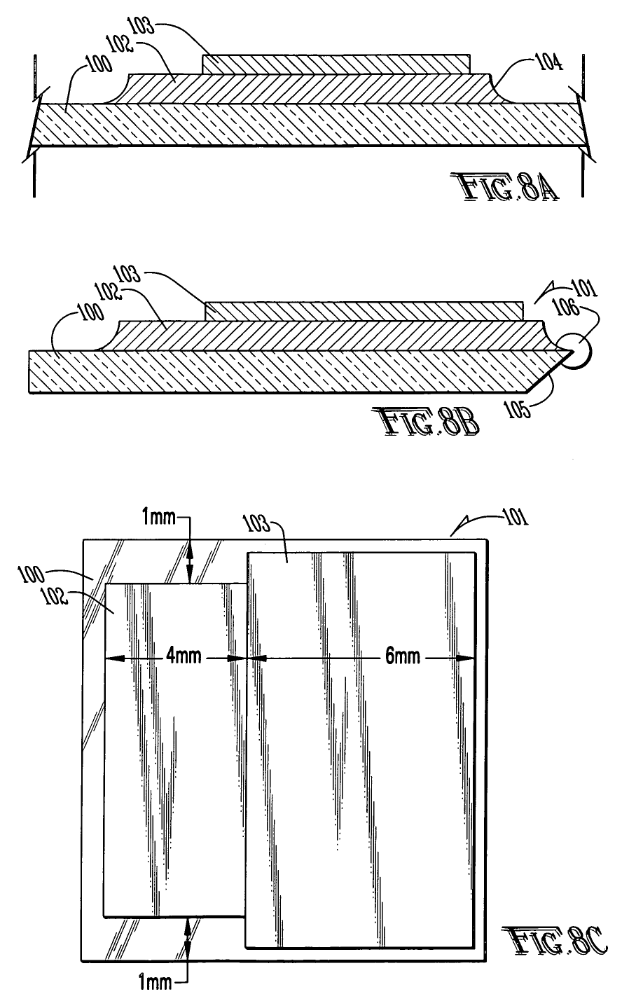

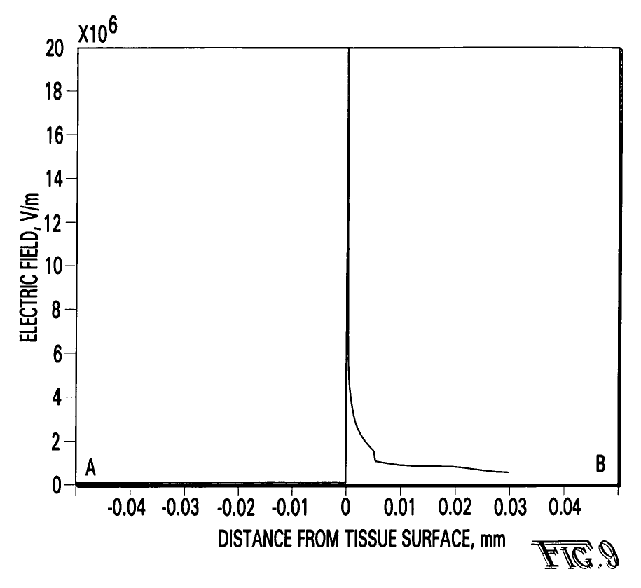

As a corollary to the above, the blade edge should not only be made with the smallest radius of curvature possible (to maximize field strength), but it should be the only portion exposed to the tissue. Any extra conductor that is not part of the high-field generation geometry serves only to pass electrical current. These considerations dictate the size and geometry of the blade, and it is clear from these effects that small dimensions and very high aspect ratios are required. Such fabrication can readily be accomplished using manufacturing procedures from thin-film based microelectronics as described above. Another proposed fabrication method and the attributes of the resulting structures are outlined as illustrated in FIGS. 7A-8C.

The fabrication substrate 100 is desirably glass, an insulator. Five inch (12.7 cm) diameter Corning 1837 class wafers would be acceptable, with a thickness of 500 microns. The aim is to end up with a blade 101 made up of a conductive layer 102 of thin-film metal on the surface of the substrate 100, such that it can be cut out using a diamond saw, connected to the power source, and handled controllably and safely during the cutting procedure. It should have an exposed low-radius edge 104, with no residual glass substrate material interfering, and should be insulated, leaving only the edge 104 exposed.

As a first step, 500 Å of Ti followed in the same vacuum by 2 μm Cu and 500 Å more of protective Ti would be sputtered onto the substrate 100 as shown in FIGS. 7A-B. Then, positive photoresist will be spun on and exposed to leave resist where we want a layer 102 of conductive blade metal to remain. The Cu is deliberately overetched in an isotropic etchant (10% H₂SO₄+5% H₂O₂) in order to obtain a “scooped” profile, giving a very small radius of curvature at the edge 104. The result is shown in FIGS. 7B and 8A, with the vertical scale exaggerated. Only one side (the right-side in FIGS. 7B and 8A) of the conductive metal layer 102 will be the actual cutting surface, but both sides have to be over etched. 5 μm of benzocylobutene (Cyclotene, Dow Chemical) is then spun on and cured to provide an insulating layer 103 to within a few micrometers of the blade tip. The substrate wafer is then sawed to isolate individual blades 101 with the result shown in FIGS. 8A-C. The broad portion of the conductive layer 102 exposed on the left of each of these drawing figures is where the electrical connection will be made and the closely insulated portion to the left will be the cutting edge 104. Then, the portion 105 of the glass substrate 100 is ground away around the edge 104 as shown in FIG. 8B. It should be remembered that it is not the purpose of the glass portion 105 or the sharp edge 104 of the metal conductive layer 102 to cut mechanically; the sectioning is done electromagnetically by the field set up at the edge 104 of the conductive metal layer 102. The final result is shown in FIGS. 8B-C. The high-field region 106 is located in the near vicinity of the edge 104, which extends a few μm's beyond insulating layer 103.

A further alternative for construction of a blade embodying the principles of the present invention is to form the blade of flexible materials. For example, the electrode of thin flexible foil made of conductive material, such as gold, platinum, copper or aluminum, may be sandwiched between two layers of flexible insulative material, such as mylar or acetate. The insulative layers do not require high insulative properties when relatively low voltages are applied to the foil electrode. Materials for the electrode that are resistant to corrosion are desirable. If materials subject to corrosion such as copper or aluminum are used, then a protective coat would be desirable. Such a protective coat may, for example, be of titanium. The foil electrode may be bonded to the insulative layers by means of any form of adhesive or bonding technique known to those skilled in the art. Once the foil electrode and insulative layers are bonded together, an edge is sheared to expose the edge of the electrode. It has been noted that such a blade is most effective when used with a sawing motion. It is hypothesized that the shearing action may form serrations on the exposed edge which serves to concentrate the electrical field at the points of the serrations. It is also possible that the sawing motion improves the efficiency of the device by removing the build up of ions in the vicinity of the zone of tissue separation. The flexible blade may be formed into a ribbon which may be wound onto a first reel and taken up by a second reel. It is therefore possible to house the flexible electrode in a cassette-type cartridge which allows a fresh blade surface to be deployed as needed. The blade could also be in the form of a disk that rotates to expose a fresh edge.

In order to achieve the precise sectioning and positioning, it is desirable to utilize a micro-erosion technology platform. This technology is being utilized in many industries to remove very small amounts of material, generally metals. The movement resolution of the system is 0.1 microns and this precision is designed into all three axes, x-y-z. In this system, the precise stepper motor driven movement is monitored utilizing glass scales that have a continuous feedback to the controller, verifying the position of the stage. The z axis is mounted vertically and is desirably used to hold the specimen. This stage controls the slice thickness (4-10 μm). The x and y axes control the motion of the blade and hold the temperature controlled containment bath. The bath temperature is desirably 2°±1 C. The bath requires active cooling to maintain a consistent temperature. The blade is rigidly mounted in a fixed and identified location and submerged within the bath. With the blade in a fixed position, the position of the specimen is detectable by detecting the field discharge, at a very slow rate of movement. Once the discharge is detected, the platform speed may be increased to affect a smooth and thermally free tissue section. This platform is desirably capable of attaining 12 mm/sec velocity. The process can be repeated as many times as necessary, incrementing the z stage 4-10 μm between each pass. Once the specimen is sectioned the tissue may be captured onto glass slides. In order to ensure proper discharge parameters are maintained, the stages are desirably electrically isolated using ceramic substrates.

Both analytical and numerical modeling indicate that very strong and highly localized electric fields can be generated in tissue using the blade geometries described herein. Temperatures can be kept sufficiently low to avoid thermal damage to surrounding tissue since the total current can be limited by a combination of judicious blade design, particularly pertaining to the insulation, and by proper shaping of the voltage waveforms. The following describes the hardware requirements to achieve voltage waveforms to give the desired field intensities without deleterious heating.

The required total voltages are in the range of one to a few hundred volts while the total current requirements are less than a few milliwatts. Taking as a worst-case scenario 1000 V and 10 mW, there are a broad range of power supplies that will accommodate this at moderate cost. It is the nature of power supplies that high current and low voltage is difficult and expensive, mainly due to induction problems associated with high di/dt, while the opposite, low current and high voltage, is considerably easier. For instance, every TV set with a picture tube contains a 25 kV power supply that supplies 100's of mA of current, both of which are many times that required for the present invention.

The simplest candidate waveform would be a flat voltage in the range indicated, which would remain on at all times during the sectioning procedure. Power supplies with these capabilities are inexpensive, uncomplicated, and plentiful, for example, the Glassman MJ series or the Bertan 210 series would be acceptable.

It should not be expected that a flat waveform would be optimal for tissue sectioning. Various other waveforms may be preferable for cleaving tissue at a maximum rate with a minimum of thermal damage. A periodic square wave with three variables, on-state voltage, on-time, and off-time, would provide a great deal of flexibility with regard to balancing rate and heating, and it is not anticipated that more complex waveforms would be necessary, such as triangular or sawtooth.

While it is possible to purchase high voltage power supplies that also include control circuitry for the purpose of shaping the waveform, it would be more flexible and less expensive to purchase a flat-wave high kV supply and chop it with a solid-state switch. In fact, a mechanical relay could almost provide chopping rates sufficient for the present invention, but more control would be provided by using a transistor-based switch. A transistor-based switch would be somewhat more complex and expensive than the power supply itself since it would involve some very fast-acting components. It is important to choose a switching system that will certainly accommodate the requirements of the present invention, and these are projected to include the following:

Independently controlled on-time and off-time (as opposed to on-time only). Times on the order of microseconds should be acceptable.

Slew rates as short as microseconds.

Low on-resistance, under 10 Ohms since this is a low current application.

Short rise and fall times, under 1/10 the minimum on-time, amounting to 100's of ns.

High voltage stability.

In an alternative embodiment of the present invention polar molecules or other additives in the cooling bath are added to the water bath. The additives, such as inorganic polar molecules or nano- or micro-sized particles, are selected from those substances that rotate in an external electromagnetic field so as to enhance the action of the electromagnetic field to break bonds in the tissue sample being sectioned. Other additives may also be selected to decompose in the electromagnetic field and produce radicals that will strongly interact with the tissue to break bonds and enhance the sectioning effect.

In addition to a cooling bath, other ways may be employed to limit thermal damage to the tissue being sectioned by minimizing the interaction time between the sectioning tool and the tissue. For example, the electromagnetic field may be pulsed to allow thermal effects to dissipate after each pulse before thermal damage occurs. Also, rapid movement of the blade through the tissue may be used to limit the time for thermal interaction. Finally, direct cooling of the tissue sample is not limited to a cooling bath, but could include cooling sprays.

If the cooling bath is conductive, increasing the conductivity extends the electric field and increases the temperature of the bath. To avoid this effect, an insulating bath such as silicone oil may be used. However, it may alternatively be desirable to utilize the effect of a conductive bath by modifying the electrical properties of the cooling bath to control the size of the electric field and the extent of thermal damage by ensuring that the bath absorbs more heat than the tissue.

In addition to pulsing the electromagnetic field, other techniques to minimize thermal effects could include using low frequencies instead of high frequencies or even DC fields in certain applications.

The present invention may be used for purposes other than tissue sectioning for analysis and diagnosis. In particular, the device may be adapted for surgical uses. For example, the device may be used to shave skin cancers. It may be very effective in procedures which require sectioning bone with no decalcification. It may also have application to procedures on the eye, such as corneal shaping and cataract removal.

The present invention has been described with reference to certain preferred and alternative embodiments that are intended to be exemplary only and not limiting to the full scope of the present invention as set forth in the appended claims.

1. An apparatus for separating tissue, comprising:
a separating tool having an edge;
and means for generating an electromagnetic field at said edge,
wherein said electromagnetic field has sufficient intensity to separate the tissue by severing structural bonds or propagating flaws in the tissue without mechanical cutting.

2. The apparatus of claim 1 wherein the tissue is a tissue specimen, further comprising:
a tissue holder;
means for moving said separating tool whereby said edge of said separating tool passes through the tissue specimen in a selected plane so as to separate sections of tissue from the tissue specimen.

3. The apparatus of claim 2, further comprising:
a cooling medium comprising additives to enhance the separation of the tissue.

4. The apparatus of claim 3, wherein said additives are selected from the group comprising inorganic polar molecules and particles.

5. The apparatus of claim 3, wherein said additives comprise substances which decompose in said electromagnetic field and release reactive species.

6. The apparatus of claim 2, wherein said means for moving said separating tool comprises a horizontal translation stage for moving said separating tool in a horizontal plane, a vertical translation stage for moving the tissue specimen in a vertical direction, and means for controlling the motion of the horizontal translation stage and the vertical translation stage.

7. The apparatus of claim 1, wherein said separating tool comprises a thin electrically conductive region positioned between electrically non-conductive regions wherein said edge is not covered by said electrically non-conductive regions.

8. The apparatus of claim 2, further comprising:
means for minimizing interaction time between said separating tool and the tissue specimen to avoid thermal damage to the tissue specimen.

9. The apparatus of claim 8, wherein said means for minimizing interaction time comprises means for pulsing said electromagnetic field.

10. The apparatus of claim 8, wherein said means for minimizing interaction time comprises movement of said separating tool through said tissue specimen at a rate adequate to maintain said tissue specimen below a predetermined temperature for avoiding thermal damage to the tissue specimen.

11. The apparatus of claim 2, further comprising:
a cooling spray.

12. An apparatus for separating tissue, comprising:
a separating tool having an edge and an electromagnetic field at said edge,
wherein said electromagnetic field has sufficient intensity to separate the tissue by severing structural bonds or propagating flaws in the tissue without mechanical cutting.

13. The apparatus of claim 12 wherein the tissue is a tissue specimen, further comprising:
a tissue holder;
a translation stage operatively associated with said separating tool whereby said edge of said separating tool passes through the tissue specimen in a selected plane so as to separate sections of tissue from the tissue specimen.

14. The apparatus of claim 13, further comprising:
a cooling medium comprising additives to enhance the separation of the tissue.

15. The apparatus of claim 14, wherein said additives are selected from the group comprising inorganic polar molecules and particles.

16. The apparatus of claim 14, wherein said additives comprise substances which decompose in said electromagnetic field and release reactive species.

17. The apparatus of claim 13, wherein said translation stage comprises a horizontal translation stage for moving said separating tool in a horizontal plane, a vertical translation stage for moving the tissue specimen in a vertical direction, and a motion controller operatively connected to said horizontal translation stage and said vertical translation stage.

18. The apparatus of claim 12, wherein said separating tool comprises a thin electrically conductive region positioned between electrically non-conductive regions wherein said edge is not covered by said electrically non-conductive regions.

19. The apparatus of claim 13 further comprising a pulsed electromagnetic field.

20. The apparatus of claim 13 wherein said translation stage moves said separating tool through said tissue specimen at a rate adequate to maintain said tissue specimen below a predetermined temperature for avoiding thermal damage to the tissue specimen.

21. The apparatus of claim 13, further comprising:
a cooling spray.
